(19) United States
(12) Patent Application Publication
(10) Pub. No.: US 2020/0289919 A1
(43) Pub. Date: Sep. 17, 2020

(54) CONFIGURATION FOR PROVIDING A USER EXPERIENCE BASED ON COMMUNICATION WITH A FOOTWEAR APPARATUS

(71) Applicant: Zero Point Energy Inc., Los Angeles, CA (US)

(72) Inventor: Jacob Yasha Gruben, New York, NY (US)

(73) Assignee: Zero Point Energy Inc., Los Angeles, CA (US)

(21) Appl. No.: 16/351,224

(22) Filed: Mar. 12, 2019

(51) Int. Cl. A63F 13/23; G06F 3/147; G06F 3/0346; H04W 4/38; H04M 1/725; A63F 13/812; A63F 13/212; A63F 13/25

(52) U.S. Cl. CPC A63F 13/23; G06F 3/147; G06F 3/0346; H04W 4/38; H04M 1/72527; A63F 2300/308; A63F 13/212; A63F 13/25; A63F 2300/8011; A63F 2300/1012; A63F 13/812

(57) ABSTRACT

A computer program product comprises a non-transitory computer useable storage device that has a computer readable program. When executed on a computer, the computer readable program causes the computer to receive, from a footwear apparatus, motion data corresponding to a foot movement of a user wearing footwear operably attached to the footwear apparatus. The motion data is measured by one or more sensors operably attached to the footwear. Further, the computer is caused to provide, with a processor positioned within a mobile computing device, a user experience based on the motion data. Additionally, the computer is caused to display, via a display device in operable communication with the mobile computing device, the user experience.

### BACKGROUND

### 1. Field

This disclosure generally relates to computing devices. More particularly, the disclosure relates to a configuration for providing a user experience based on communication with a footwear apparatus.

### 2. General Background

Recent developments in technology have led to various activity tracking devices (e.g., smartwatches) that may be worn by a user during a physical activity, such as running. The activity tracking device is typically worn on the wrist, and may have one or more sensors that attempt to determine activity based on periodic bursts of motion. For example, a conventional activity tracking device may have an accelerometer integrated therein. To track steps taken by a user, a conventional activity tracking device will typically count the number of times a user moves his or her wrist—presuming that each motion of the wrist corresponds to a step taken in the natural walking/running stride of a user.

Yet, such presumptions may often lead to inaccurate activity tracking measurements. For example, a user's hands may be preoccupied during a physical activity (e.g., pushing a cart, holding a smartphone, etc.). In other words, the feet of the user may be moving while the hands of the user are relatively stationary, thereby leading to uncounted steps by the activity tracking device. Alternatively, the user's hands may be moving while the user is relatively stationary (e.g., sitting while taking a break from the physical activity), which could result in steps being added even though no steps were actually taken.

As a result, conventional activity tracking devices placed on the wrist of a user do not accurately measure physical activities of a user.

### SUMMARY

In one embodiment, a computer program product comprises a non-transitory computer useable storage device that has a computer readable program. When executed on a computer, the computer readable program causes the computer to receive, from a footwear apparatus, motion data corresponding to a foot movement of a user wearing footwear operably attached to the footwear apparatus. The motion data is measured by one or more sensors operably attached to the footwear. Further, the computer is caused to provide, with a processor positioned within a mobile computing device, a user experience based on the motion data. Additionally, the computer is caused to display, via a display device in operable communication with the mobile computing device, the user experience.

In another embodiment, a different computer is caused to sense, with one or more sensors operably attached to a footwear apparatus, a foot movement of a user wearing footwear operably attached to the footwear apparatus. Further, the computer is caused to send, from the footwear apparatus to a mobile computing device, motion data corresponding to the foot movement of the user wearing the footwear such that the mobile computing device provides a user experience based on the motion data.

In yet another embodiment, a footwear apparatus has footwear in which a foot of a user is positioned. Further, the footwear apparatus has a sensor that senses a foot movement of a user wearing the footwear. The sensor is operably attached to the footwear. Moreover, the footwear apparatus has a transmitter that sends, from the footwear apparatus to a mobile computing device, motion data corresponding to the foot movement of the user wearing the footwear such that the mobile computing device provides a user experience based on the motion data. The transmitter is operably attached to the footwear.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a user experience configuration that may be used to generate a user experience based on communication between a footwear apparatus and a mobile computing device.

FIG. 2 illustrates an example of a user that uses the footwear apparatus in conjunction with the mobile computing device, which are both illustrated in FIG. 1, to view, and/or participate in, a user experience.

FIG. 3A illustrates the display unit rendering a profile screen corresponding to an avatar for the user illustrated in FIG. 2, upon the user activating the avatar indicium.

FIG. 3B illustrates the display unit rendering a map screen, upon the user activating the map indicium from the menu, corresponding to various benchmark indicia that may be earned by the user at various physical locations.

FIG. 3C illustrates a metrics screen that provides a graphical representation of the activity of the user, based upon the user activating the metrics indicium from the menu.

FIG. 3D illustrates a detailed metrics screen that may provide more detailed activity to the user, based upon the user activating the metrics indicium from the menu or activating an additional indicium displayed within the metrics screen illustrated in FIG. 3C.

FIG. 4A illustrates the user positioned within a real-world environment (e.g., street with a nearby building).

FIG. 4B illustrates the display unit of the AR glasses rendering the virtual soccer ball as it is about to be kicked by the user.

FIG. 4C illustrates the user, in the real-world, kicking the virtual soccer ball illustrated in FIGS. 4A and 4B.

FIG. 4D illustrates the calculated trajectory of the virtual soccer ball toward the virtual soccer net, as rendered by the display unit of the AR glasses.

FIG. 4E illustrates a user kicking the virtual soccer ball toward a side of a building.

FIG. 4F illustrates another example of the user using the footwear apparatus to interact with a virtual object during an AR experience.

FIG. 4G illustrates the user tapping the virtual object to open the virtual object in the AR experience.

FIG. 4H illustrates another example of the user using the footwear apparatus to interact with virtual kicking indicia during an AR experience.

FIG. 4I illustrates an alternative to the configuration illustrated in FIG. 4A.

FIG. 5A illustrates the user positioned within a real-world environment (e.g., street with a nearby building).

FIG. 5B illustrates the display unit of the AR glasses rendering the virtual hurdle as the user is about to jump over it.

FIG. 5C illustrates the user, in the real-world, jumping over the virtual hurdle in FIGS. 5A and 5B.

FIG. 5D illustrates the calculated trajectory of one or both feet of the user with respect to the virtual hurdle, as rendered by the display unit of the AR glasses.

FIG. 6A illustrates the user positioned within a real-world environment.

FIG. 6B illustrates the display unit of the AR glasses rendering the virtual basketball net as the user is about to throw the virtual basketball toward it.

FIG. 6C illustrates the user, in the real-world, jumping to throw the virtual basketball toward the virtual basketball net.

FIG. 6D illustrates the calculated trajectory of the virtual basketball with respect to the virtual basketball net.

FIG. 7 illustrates a process that may be used by the mobile computing device, illustrated in FIG. 1, to render a user experience based on motion data captured by the footwear apparatus, also illustrated in FIG. 1.

FIG. 8 illustrates a process that may be used by the footwear apparatus, illustrated in FIG. 1, to sense motion data of a foot of a the user, illustrated in FIG. 2.

### DETAILED DESCRIPTION

A user experience configuration is provided herein to render a user experience for a user of a mobile computing device (e.g., smartphone, smart glasses, etc.) based on communication with a footwear apparatus. In contrast with previous configurations, the user experience configuration receives data from one or more sensors positioned within various forms of footwear (e.g., shoe, sneaker, boot, slipper, sandal, etc.). By placing such sensors within footwear, rather than on the wrist of a user, the user experience configuration is able to more accurately determine the position of the foot of a user, thereby more accurately tracking physical activity corresponding to the user. For example, a user may hold a smartphone in a steady position (i.e., to talk, send text messages, listen to music, etc.) while walking, and have a number of steps accurately counted. Further, the user may sit and freely move his or her hands, without having an impact on the number of steps accurately counted. Such placement of the sensors also allows for generating a user experience based on physical interaction of one or more feet with one or more virtual objects in the user experience.

Various types of user experiences may be generated as a result of communication with the footwear apparatus. Firstly, an activity tracking software application may be used to track fitness activity of a user based on data received from the footwear apparatus. Secondly, a game software application may be used to provide a gaming experience to the user based on the data received from the footwear apparatus. Thirdly, an augmented reality (“AR”) or virtual reality (“VR”) software application may be used to provide an AR/VR experience to the user based on the data received from the footwear apparatus. The foregoing user experiences are provided only as examples, and are provided herein only for illustrative purposes. (Other possible user experiences may be generated as a result of communication with the footwear apparatus.)

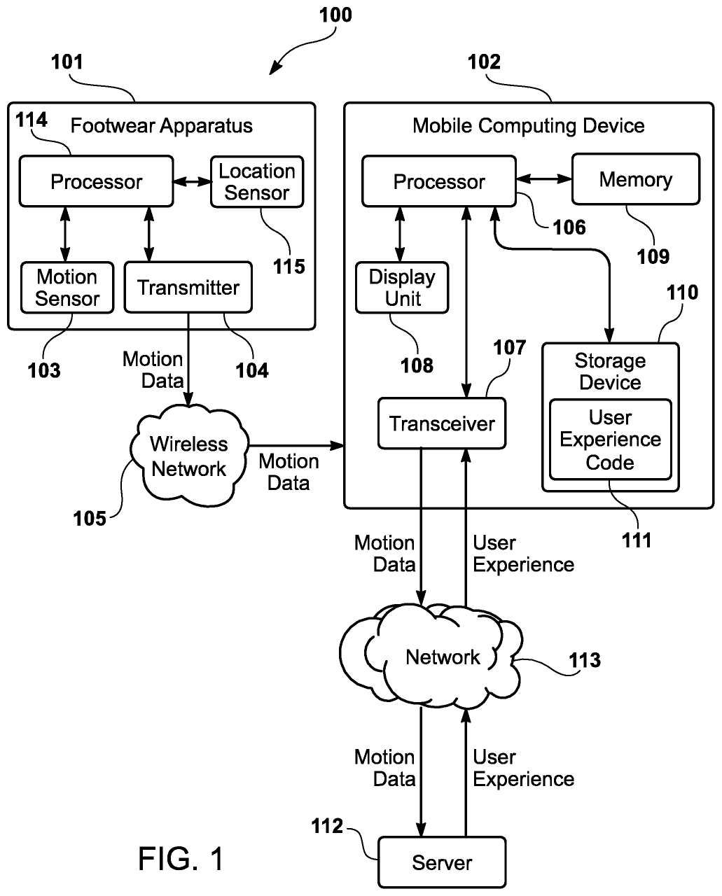

FIG. 1 illustrates a user experience configuration 100 that may be used to generate a user experience based on communication between a footwear apparatus 101 and a mobile computing device 102.

For instance, the footwear apparatus 101 may have various componentry (processors, processing boards, circuitry, sensors, etc.) that are integrated within, or operably attached to, footwear (e.g., shoe, sneaker, boot, slipper, sandal, etc.). For example, the footwear apparatus 101 may have a processor 114 that coordinates various operations (e.g., capturing sensed data, performing calculations on the sensed data, performing communication operations between internal and/or external devices with respect to the footwear, etc.). The processor 114 may also have various sensors, such as a motion sensor 103 (e.g., accelerometer, gyroscope, magnetometer, etc.) that detects motion of the footwear. In other words, the processor 114 directly detects motion of a foot of the user, rather than indirectly via a hand of the user, thereby more accurately determining the foot motion of a user. Further, the footwear apparatus 101 may have a transmitter 104 that is used to transmit the sensed motion data from the footwear apparatus 101. For example, the transmitter 104 may transmit the sensed motion data, via a wireless network 105, to the mobile computing device 102. (Alternatively, the transmitter 104 may transmit the sensed motion data via a wired connection, such as a USB cable, to the mobile computing device 102.)

Upon receiving the sensed motion data, the mobile computing device 102 (e.g., smartphone, tablet device, smart glasses, etc.) uses various componentry to generate a user experience. For example, the mobile computing device 102 may have a processor 106 that coordinates the operations of various componentry within the mobile computing device 102. The processor 106 may perform operations by executing code stored in a memory device 109. As an example, the mobile computing device 102 may have a storage device 110 that stores user experience code 111, which may be used to provide a user experience based on the sensed motion data. The mobile computing device 102 may also have a transceiver 107, or a stand-alone receiver, which receives the sensed motion data via the wireless network 105 from the transmitter 104 of the footwear apparatus 101. In one embodiment, the user experience is generated via a cloud configuration. For example, the transceiver 107 may send the sensed motion data via a network 113 (computerized, telecommunications, etc.) to a remotely located server 112, which may generate a user experience from the sensed motion data. The server 112 may then send the user experience via the network 113 to the mobile computing device 102 to render the user experience at the mobile computing device 102. In other words, the server 112, which may have more computational capacity than the mobile computing device 102, may perform computationally intensive calculations (e.g., for an AR experience) so that the mobile computing device 102 does not have to perform such calculations, thereby improving computational efficiency. In an alternative embodiment, the processor 106 in the mobile computing device 102 may directly perform the calculations to generate the user experience.

Upon the user experience being generated, either directly or indirectly, the processor 106 renders the user experience on a display unit 108 (e.g., display screen of a smartphone, glass portion of smart glasses, etc.). Optionally, the mobile computing device 102 may also have various audio devices (e.g., audio speakers) that may be used to enhance the visual aspects of the user experience.

As an alternative to the mobile computing device 102, a computing device such as a desktop computer or a kiosk may be used herein.

Finally, in one embodiment, the footwear apparatus 101 may optionally have a location sensor 115 (e.g., GPS device) that determines the real-world coordinates corresponding to the physical location of the footwear apparatus 101; such location data may be used by the processor 114 of the footwear apparatus 101 and/or the processor 106 of the mobile computing device 102 to generate the user experience in conjunction with the sensed motion data. For example, the user experience may be an AR experience that combines the sensed motion data with graphical imagery generated based upon a particular location corresponding to GPS coordinates of the footwear apparatus 101. In another embodiment, the location sensor 115 may be positioned within the mobile computing device 102.

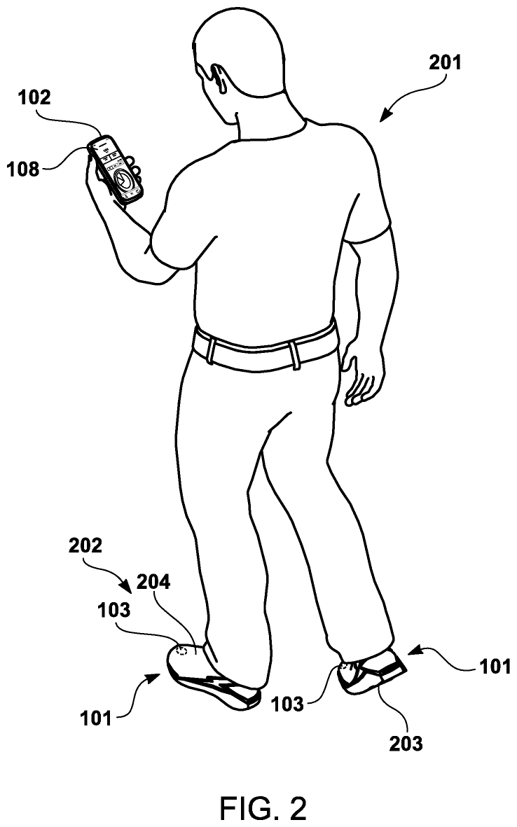

FIG. 2 illustrates an example of a user 201 that uses the footwear apparatus 101 in conjunction with the mobile computing device 102, which are both illustrated in FIG. 1, to view, and/or participate in, a user experience. The user 201 may then view the user experience via the display unit 108 during, or at the completion of, a physical activity. For example, the user 201 may view various activity graphics corresponding to various metrics (e.g., steps taken, calories burned, etc.) via the display unit 108; such metrics are generated based on motion data sensed by the motion sensor 103 of the footwear apparatus 101.

In one embodiment, the footwear apparatus 101 may be partially integrated within a sole portion 203 of footwear 202 and partially integrated within a top portion 204 of the footwear 202. For example, the processing componentry (e.g., processor 114) may be positioned within the sole portion 203, whereas the sensing componentry (e.g., motion sensor 103) may be positioned at the top portion 204. The various componentry of the footwear apparatus 101 may communicate via various types of connectivity (e.g., wireless or wired). By having the motion sensor 103 positioned at the top portion of 204 of the footwear 202, the processor 114 is able to generate virtual objects at positions that coincide with real-world positioning of the foot of the user 201. Although the motion sensor 103 is illustrated as being positioned at the top portion 204, the motion sensor 103 may, alternatively, be positioned at other portions (e.g., front, side, rear, bottom, or a combination thereof) of the footwear 202.

In another embodiment, the footwear apparatus 101 may be fully integrated within portions of the footwear 202 other than the sole portion 203. For example, the motion sensor 103 may be positioned at the top portion 204, the processor 114 may be positioned at a rear portion of the footwear 202, and the transmitter 104 may be positioned on a side portion of the footwear 202. (The foregoing example is provided solely for illustrative purposes; the various componentry of the footwear apparatus 101 may be positioned individually, or in combination, at, or within, various portions of the footwear 202.)

In yet another embodiment, the footwear apparatus 101 may be fully integrated within the sole portion 203 of the footwear 202.

Although the footwear apparatus 101 is illustrated in FIG. 2 as being integrated within the footwear 202, in an alternative embodiment, the footwear apparatus 101 may be externally attached to the footwear 202. For example, the top portion 204 may have a connector (e.g., VELCRO® brand fastener, clip, magnet, etc.) that adheres to the motion sensor 103, or a connector thereof. As another example, the motion sensor 103 may be adhered to the footwear 202 without the footwear having a connector placed thereon (e.g., via a connection device such as a strap). The foregoing examples of attachment approaches are not limited to attachment of the motion sensor 103 to the footwear 202, and may also be used to attach other componentry (e.g., processor 114 or transmitter 104) to the footwear 202.

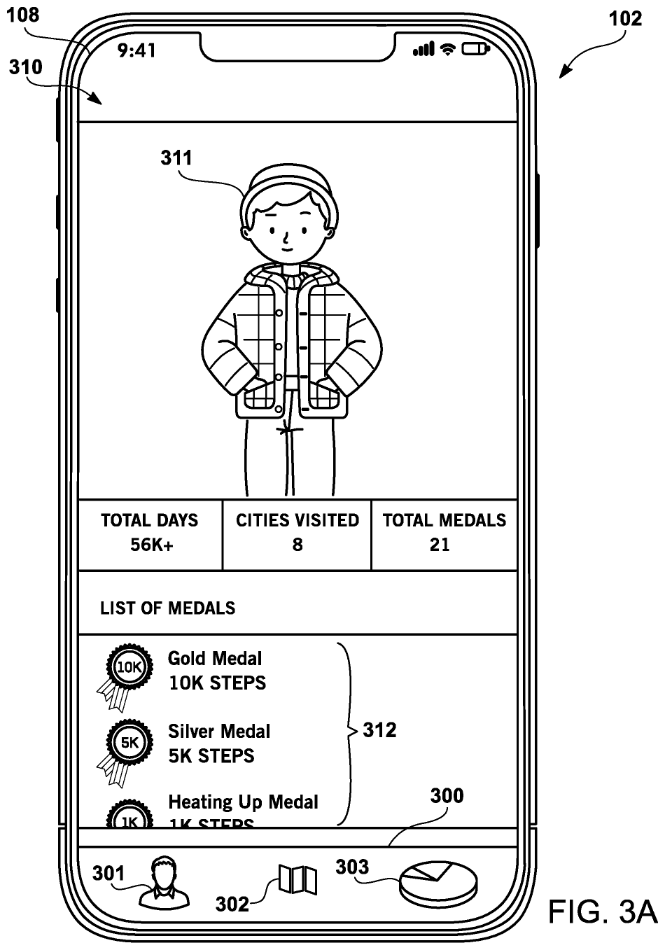

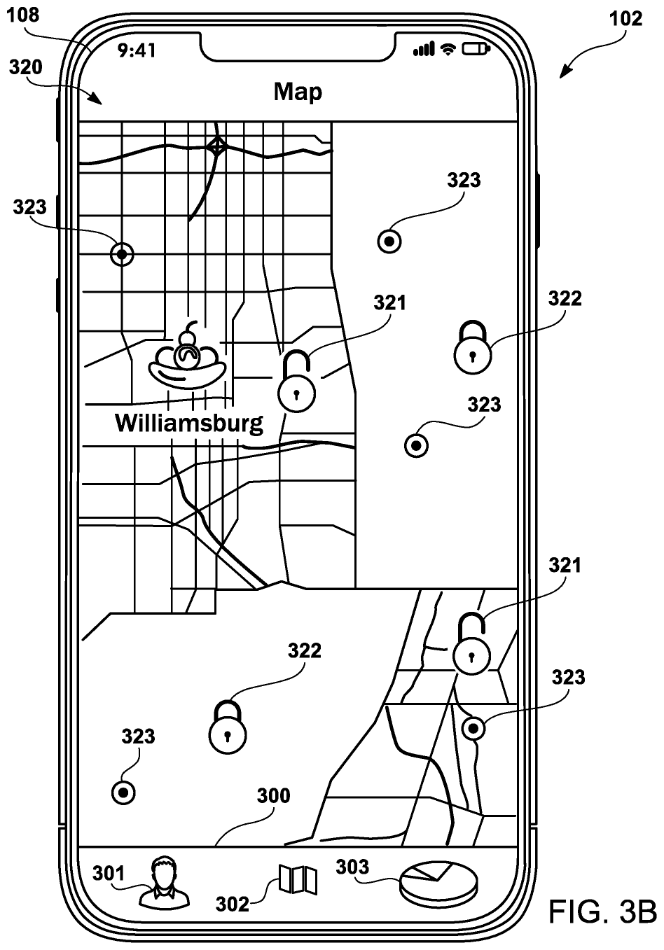

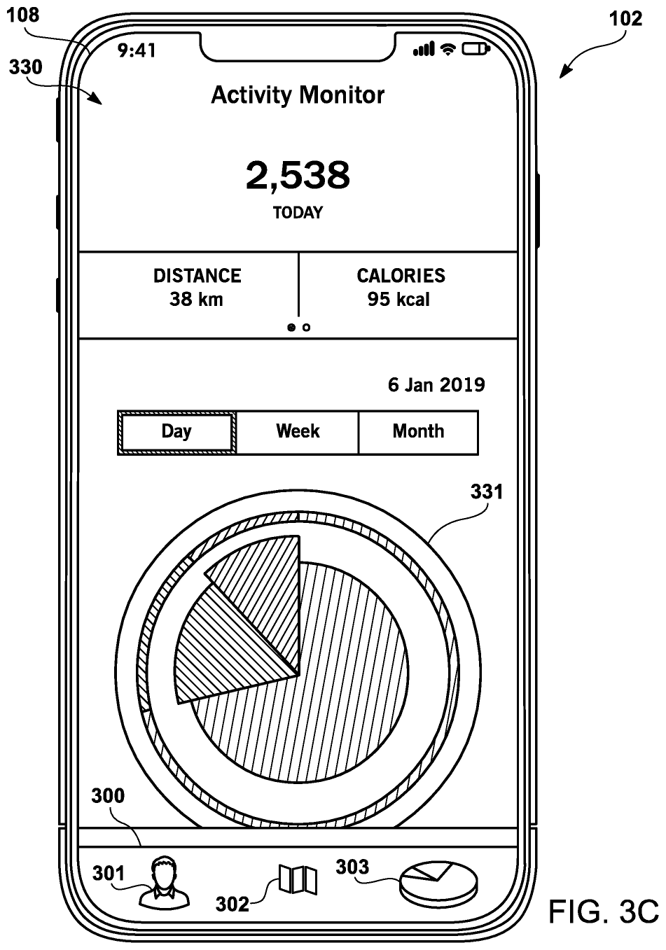

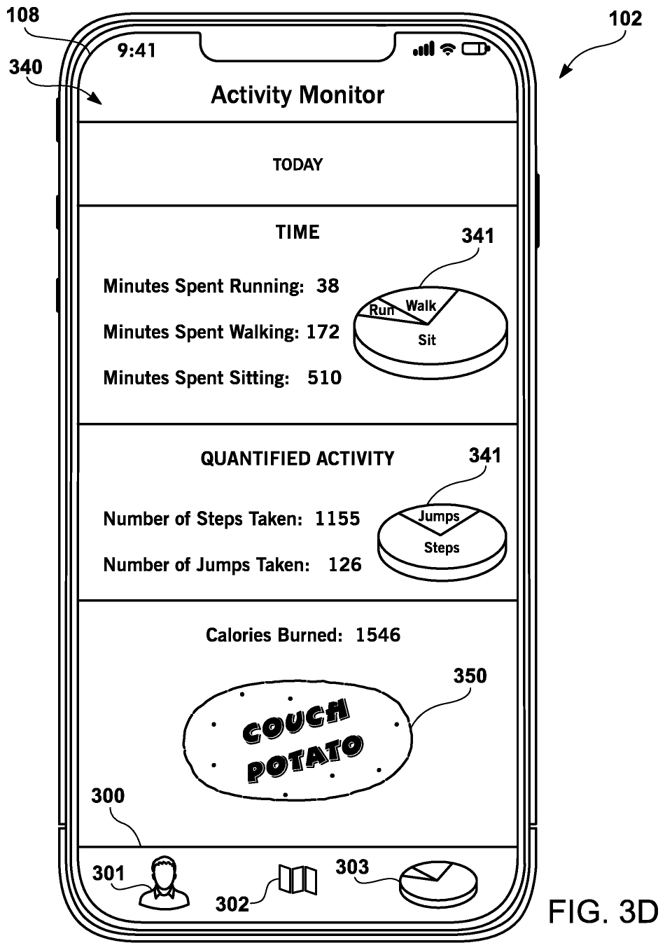

FIGS. 3A-3D illustrate example screen displays of the display unit 108 of the mobile computing device 102, illustrated in FIG. 1. A menu 310 may be displayed throughout the various screen displays to allow the user 201 to navigate to the various screen displays. For example, the menu 300 may have an avatar indicium 301, a map indicium 302, and a metrics indicium 303. (An indicium may be an icon, button, etc.)

FIG. 3A illustrates the display unit 108 rendering a profile screen 310 corresponding to an avatar 311 for the user 201 illustrated in FIG. 2, upon the user 201 activating the avatar indicium 301. In one embodiment, the avatar 311 of the user 201 may be displayed by the display unit 108 during performance of an activity (e.g., walking, running, etc.) by the user 201. In particular, the movement of the avatar 311 is calculated, and rendered, based upon the foot position sensed by the motion sensor 103 illustrated in FIG. 1. Accordingly, as the user 201 takes a real-world step, the avatar 311 may take a corresponding virtual step.

Alternatively, the avatar 311 may be displayed without any avatar manipulation during a physical activity of the user 201. For example, the avatar 311 may be rendered to display what benchmarks 312 have been achieved by the user 201. The benchmark indicia 312 (e.g., virtual medals, virtual clothing, virtual shoes, virtual hats, virtual headphones, etc.) may be displayed in the profile screen 310 based upon the completion of various tasks. For example, the user 201 may win a gold medal for walking ten thousand steps or a silver medal for walking five thousand steps, as determined by the processor 114 (FIG. 1) via the motion data sensed by the motion sensor 103 (FIGS. 1 and 2). The activity may be measured within a particular time period (e.g., a day or a week), or without any reference to a time period (e.g., total activity for the user 201 without respect to time). Alternatively, the task may be event-based. For example, the user 201 may win a medal for attending a particular event (e.g., concert) at a particular location, as determined by the location sensor 115, illustrated in FIG. 1. As yet another example, the task may be event-based and activity-based. For example, the user 201 may have to be positioned at a particular concert hall, as determined by the location sensor 115, and dance at that concert for a particular time period, as determined by the motion sensor 103 and the processor 114, to earn a particular medal. In other words, earning a benchmark indicium 311 may predicated on active participation of the user 201 at a particular physical location.

In one embodiment, the benchmark indicia 312 are rendered in a portion of the profile screen 310 in an area other than that which displays the avatar 311. Accordingly, the user 201 may swipe/scroll through the various earned benchmark indicia 312. In another embodiment, the benchmark indicia 312 may be positioned directly on the avatar 311. For example, a gold medal may be positioned on the shirt/jacket of the avatar 311. As another example, the user 201 may select which benchmark indicia he or she wants to be worn by the avatar 311 at a given moment (e.g., switch between different hats that have been won as a result of reaching various activity-based and/or event-based goals).

Earning a benchmark indicium 312 may be associated with a particular reward. For example, a gold medal may result in a free meal at a particular restaurant, free concert tickets, etc. Alternatively, the benchmark indicium 312 may not be associated with a reward other than achieving a particular goal of the user 102. For instance, a benchmark indicium 312 may be customized by the user 102 (e.g., reaching ten thousand steps in one week), rather than being pre-generated.

Further, FIG. 3B illustrates the display unit 108 rendering a map screen 320, upon the user 201 activating the map indicium 302 from the menu 300, corresponding to various benchmark indicia 312 that may be earned by the user 201 at various physical locations. The map screen 320 illustrates the benchmark indicia 312, which may be won or have already been won, at various real-world locations in a particular geographical locale (e.g., city, city neighborhood, etc.). In one embodiment, the benchmark indicia 312 that have already been earned may be illustrated as unlocked benchmark indicia 321, whereas the benchmark indicia 312 that are still locked may be illustrated as locked benchmark indicia 322. The location sensor 115, illustrated in FIG. 1, may determine the particular position of the user 201 with respect to the map screen 320.

Moreover, FIG. 3C illustrates a metrics screen 330 that provides a graphical representation of the activity of the user 201, based upon the user 201 activating the metrics indicium 303 from the menu 300. For instance, the activity screen 330 may display a graph 331 that provides the user 201 with a graphical view of how his or her activity is distributed within a given time period (e.g., day, week, month). The metrics displayed by the metrics screen 330 may be generated independently of whether or not the user 201 has participated in earning benchmark indicia 312.

Finally, FIG. 3D illustrates a detailed metrics screen 340 that may provide more detailed activity to the user 201, based upon the user 201 activating the metrics indicium 303 from the menu 300 or activating an additional indicium displayed within the metrics screen 330 illustrated in FIG. 3C. For example, activity by time, type of activity, and calories burned may be displayed. Additionally, an activity indicium 350 (e.g., couch potato) may be displayed.

In the alternative, or in addition, to the activity tracking functionality described with respect FIGS. 3A-3D, the footwear apparatus 101, illustrated in FIG. 1, may be used in conjunction with the mobile computing device 102, illustrated in FIG. 1, to provide a user experience that is partially, or entirely, virtual-based.

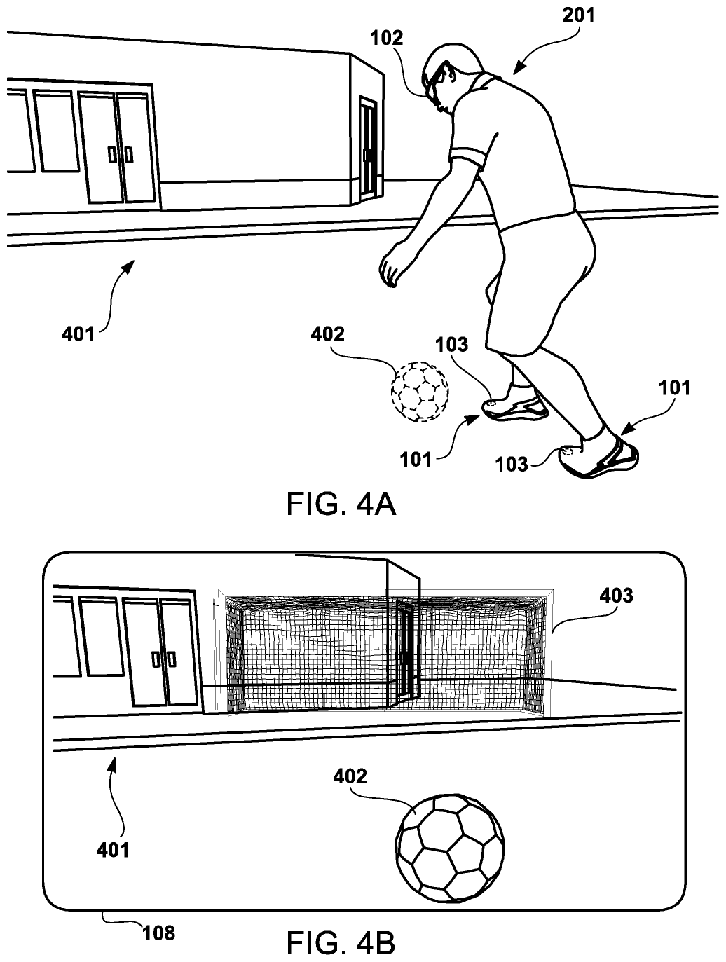

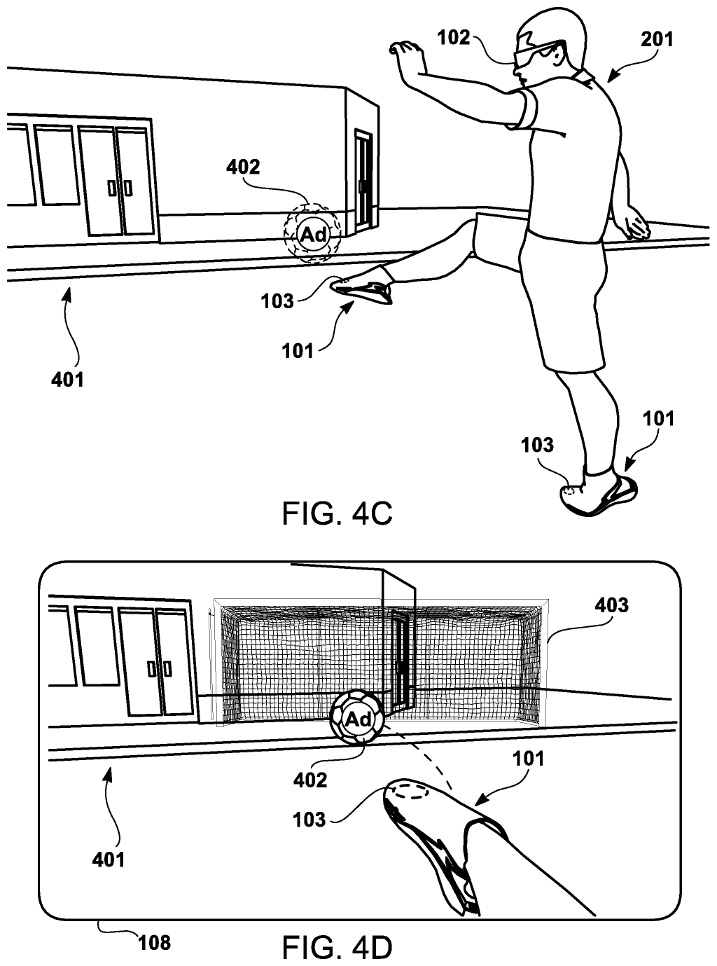

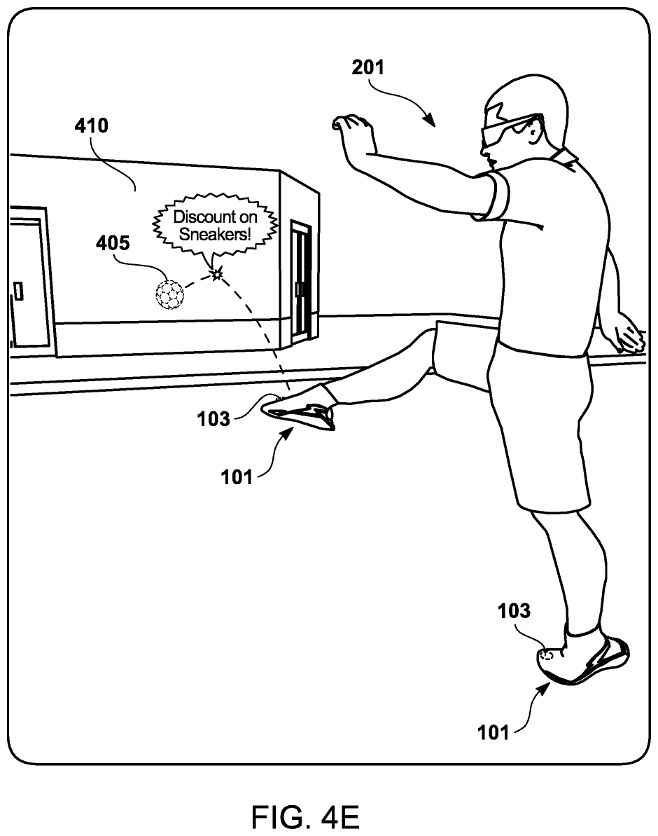

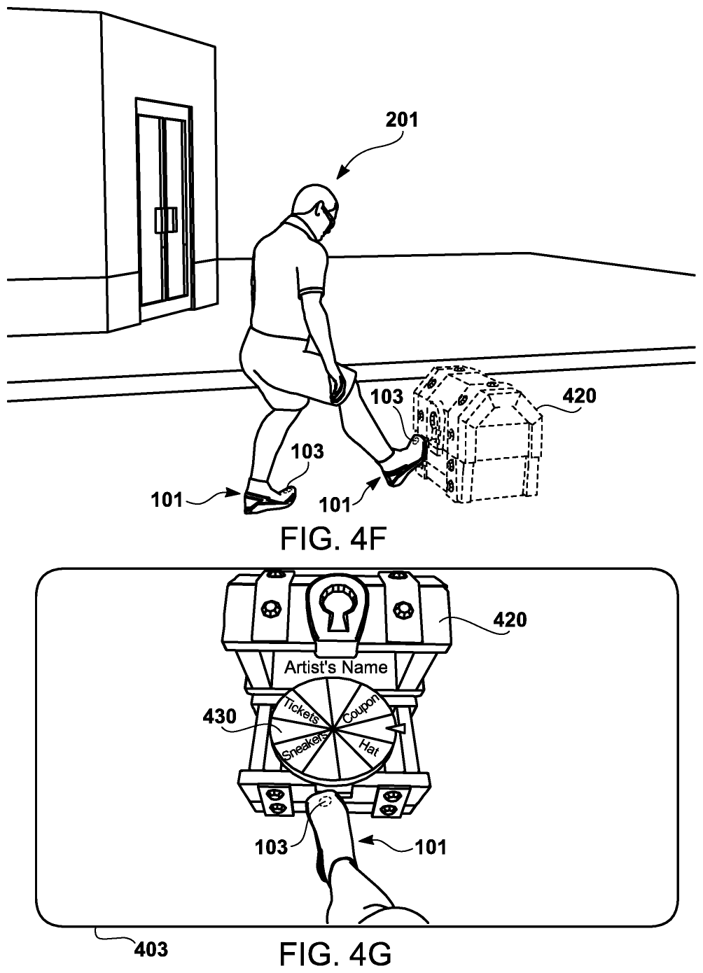

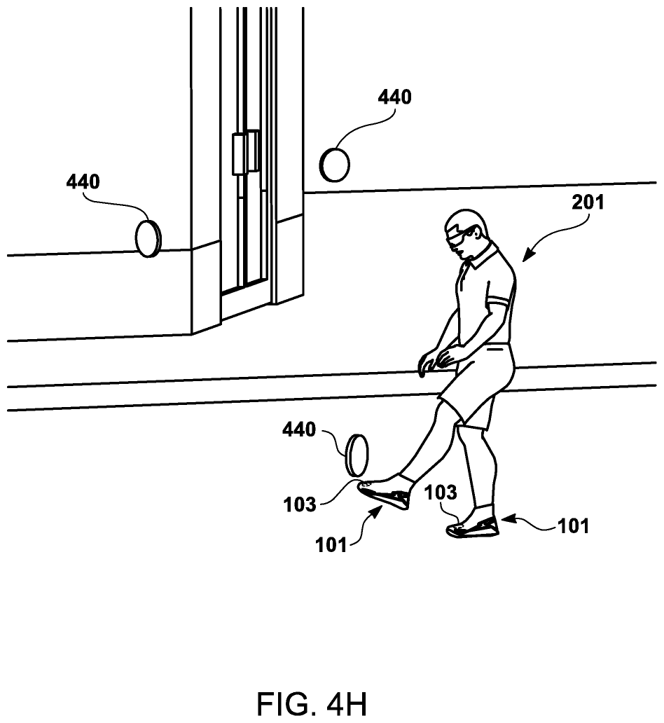

As an example, FIGS. 4A-4D illustrate the footwear apparatus 101 being used in conjunction with a pair of AR glasses as the mobile computing device 102 to provide an AR soccer experience. FIG. 4A illustrates the user 201 positioned within a real-world environment 401 (e.g., street with a nearby building). Although the user 201 is not positioned on, or in proximity to, a soccer field, the user 201 may be a soccer enthusiast that wants to enjoy playing soccer, even without a real-world soccer ball away from a soccer field.

Accordingly, the user 201 may use the footwear apparatus 101 to track the motion of one or both feet of the user 201, via the motion sensor 103. The mobile computing device 102 may then receive the sensed motion data, and generate an AR soccer experience/game for the user 201. In other words, the glass portion of the AR glasses displays various virtual objects (e.g., virtual soccer ball 402) within the context of the real-world environment 401 based on the sensed motion data determined by the motion sensor 103. As a result, the AR glasses 102 are able to render a real-time, or substantially real-time, depiction of the virtual soccer ball 402 with respect to the real-world placement of one or both feet of the user 201.

Further, FIG. 4B illustrates the display unit 108 of the AR glasses 102 rendering the virtual soccer ball 402 as it is about to be kicked by the user 201. From the particular vantage point illustrated in FIG. 4B, the AR glasses 102 may also render additional virtual imagery (e.g., virtual soccer net 403) via the display unit 108. Accordingly, the user 201 has a reference point with which to aim his or her kick of the virtual soccer ball 401.

FIG. 4C illustrates the user 201, in the real-world, kicking the virtual soccer ball 402 illustrated in FIGS. 4A and 4B. By tracking the motion of the motion sensor 103 (e.g., displacement, velocity, etc.), the processor 114 of the footwear apparatus 101 may determine a trajectory of the virtual soccer ball 402. Alternatively, the processor 106 of the AR glasses 102 may determine the trajectory of the virtual soccer ball 402 based on the sensed motion data.

In one embodiment, the processor 104 of the footwear apparatus 101 may use the location sensor 115, illustrated in FIG. 1, to customize the user experience based on location data sensed by the location sensor 115 and motion data sensed by the motion sensor 103. For example, the processor 104 may customize virtual imagery such as the virtual soccer ball 402 to display an image based on the location of the user 201 (e.g., promotion such as an advertisement for goods or services in the local geographical area). The image may be an advertisement for virtual items for the avatar 311, illustrated in FIG. 3A, or real-world items. Further, the processor 104 may access a user profile, which may be stored by the storage device 110 stored on the mobile computing device 102, to tailor the user experience to the user 201 based on one or more user preferences of the user 201. Alternatively, the user profile may be stored on a different storage device (e.g., a storage device associated with the server 112 or a storage device that is integrated into, or operably attached to, the footwear apparatus 101). In yet another embodiment, the processor 106 in the mobile computing device 102 is in operable communication with the location sensor 115, or has an integrated location sensor 115, to allow the processor 106 to perform the user experience customization based on the location data.

FIG. 4D illustrates the calculated trajectory of the virtual soccer ball 402 toward the virtual soccer net 403, as rendered by the display unit 108 of the AR glasses 102.

Although the processing for rendering, and/or calculating coordinates, for the virtual objects may be performed entirely by the processor 106 of the AR glasses 102, such processing may be performed partially by the processor 106 and partially by another processor of an additional computing device (e.g., processor 114 of the footwear apparatus 101, server 107, smartphone, smartwatch, etc.) that may be in operable communication with the AR glasses 102. Alternatively, such other processor may perform such processing in its entirety without being performed in conjunction with the processor 106.

FIG. 4E illustrates a user 201 kicking the virtual soccer ball 405 toward a side of a building 410. Based on the calculated trajectory, as determined by the sensed motion via the motion sensor 103, the processor 104 of the footwear apparatus, or the processor 106 of the mobile computing device 102, is able to determine whether the virtual soccer ball 405 will collide with the side of the building 410. As a result of such a collision, the processor 114 of the footwear apparatus, or the processor 106 of the mobile computing device 102, generates virtual imagery (e.g., localized advertisements for discounts on products located within a real-world store corresponding to the side of the building 410) for display on the side of the building 410.

Accordingly, the footwear apparatus 101 may be used to customize virtual imagery of an AR experience based on location data corresponding to a real-world location of the user 201, and sensed motion data corresponding to motion of the foot of the user 201.

Moreover, FIG. 4F illustrates another example of the user 201 using the footwear apparatus 101 to interact with a virtual object 420 during an AR experience. For instance, the user 201 may tap the virtual object 420 (e.g., virtual mystery box) to open the virtual object 420 in the AR experience, as illustrated by FIG. 4G. As a result of opening the virtual object, a promotion (e.g., name of an artist having a local event), as determined via location data and/or a user profile, may be displayed within the virtual object 420. Further, activating the virtual object 420 may activate an AR-based game (e.g., a spinning virtual wheel 430 having different potential prizes that result from a randomly generated outcome).

Further, FIG. 4H illustrates another example of the user 201 using the footwear apparatus 102 to interact with virtual kicking indicia 440 (e.g., virtual coins) during an AR experience. The user may participate in an AR-based game that depends on gathering virtual coins by kicking them, as determined by the motion sensor 103, illustrated in FIG. 1.

Finally, FIG. 4I illustrates an alternative to the configuration illustrated in FIG. 4A. In particular, the user 201 may use a smartphone as the mobile computing device 201, rather than AR glasses. Thus, the mobile computing device 201 is not limited to AR glasses or a smartphone.

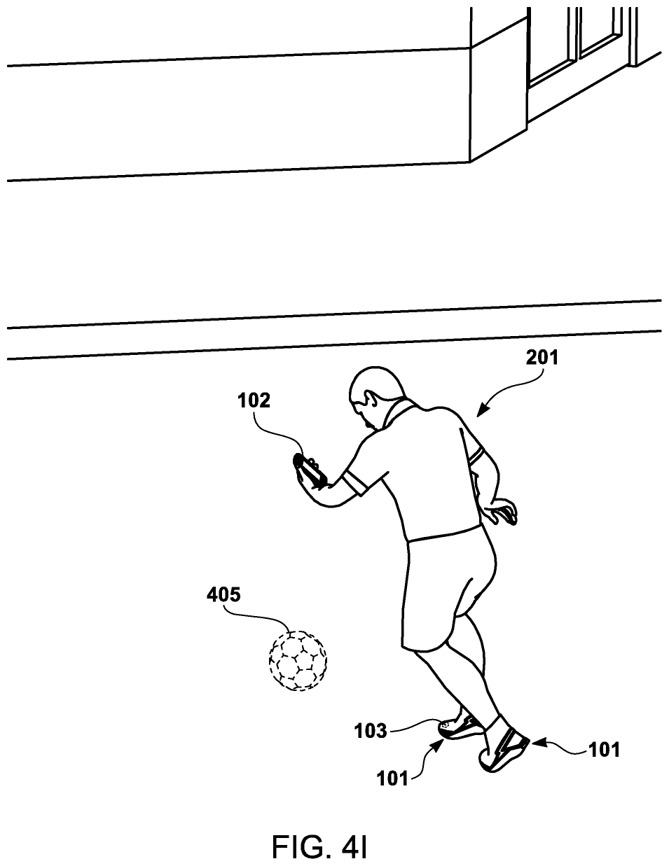

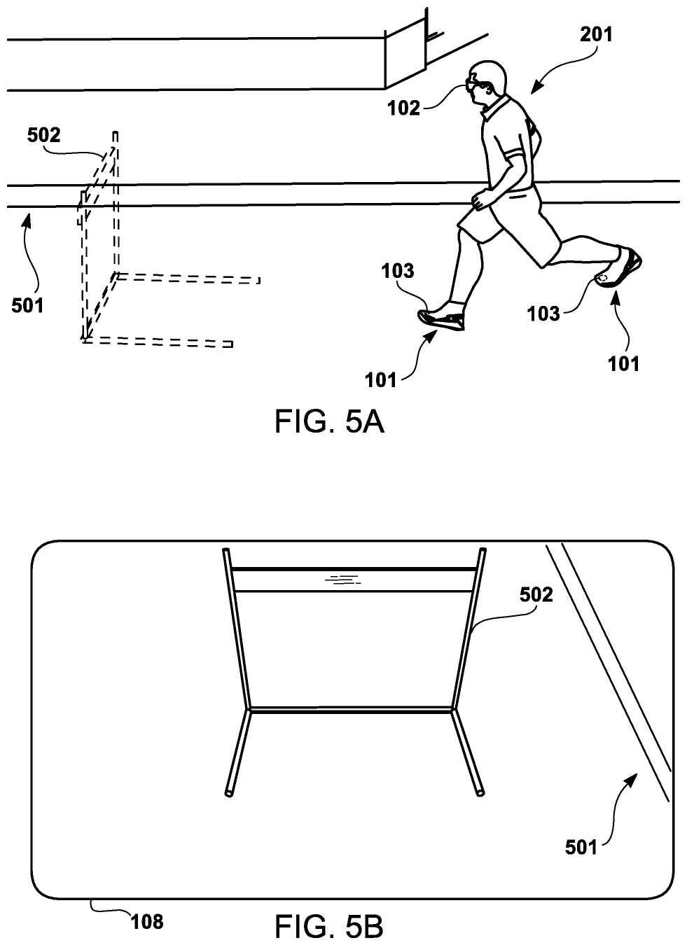

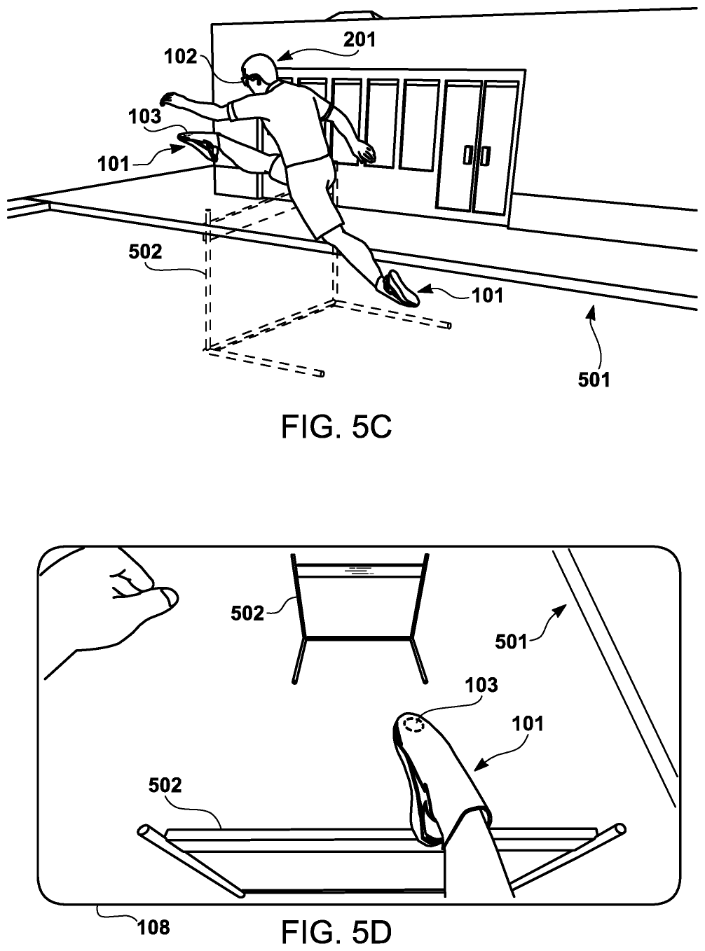

As another example, FIGS. 5A-5D illustrate the footwear apparatus 101 being used in conjunction with a pair of AR glasses as the mobile computing device 102 to provide an AR track and field experience. FIG. 5A illustrates the user 201 positioned within a real-world environment 501 (e.g., street with a nearby building). Although the user 201 is not positioned on, or in proximity to, a track, the user 201 may be a track and field enthusiast that wants to enjoy jumping over hurdles, even without a real-world track; or the user 201 may want to obtain the exercise benefits of jumping hurdles without the potential danger of falling over a physical hurdle. Further, FIG. 5B illustrates the display unit 108 of the AR glasses 102 rendering the virtual hurdle 502 as the user 201 is about to jump over it.

FIG. 5C illustrates the user 201, in the real-world, jumping over the virtual hurdle 502 in FIGS. 5A and 5B. By tracking the motion of the motion sensor 103 (e.g., displacement, velocity, etc.), the processor 114 of the footwear apparatus 101 may determine a trajectory of one or both feet of the user 201 with respect to the virtual hurdle 502. FIG. 5D illustrates the calculated trajectory of one or both feet of the user 201 with respect to the virtual hurdle 502, as rendered by the display unit 108 of the AR glasses 102. As a result, the user 201 may view, via the AR glasses 102, whether or not his or her feet cleared the virtual hurdle 502, and by how much.

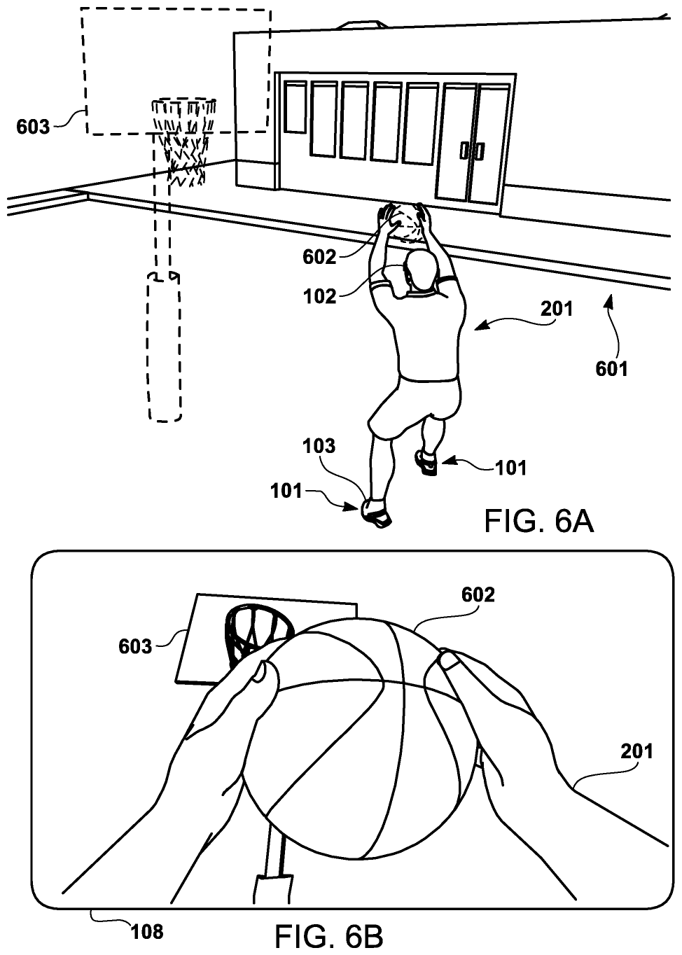

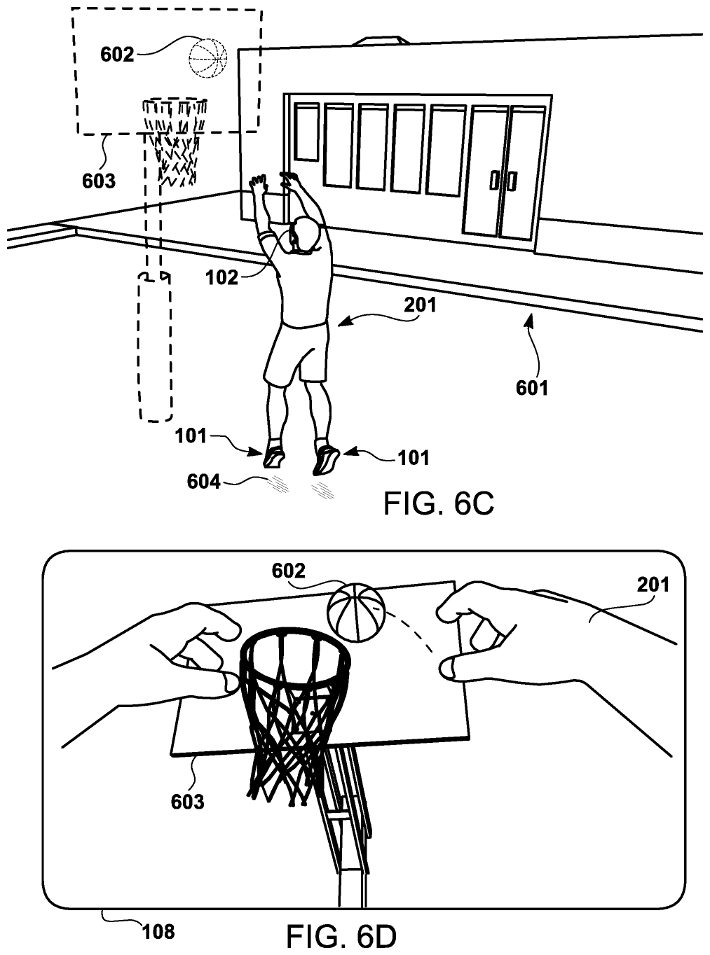

As another example, FIGS. 6A-6D illustrate the footwear apparatus 101 being used in conjunction with a pair of AR glasses as the mobile computing device 102 to provide an AR basketball experience. FIG. 6A illustrates the user 201 positioned within a real-world environment 601 (e.g., street with a nearby building). Although the user 201 is not positioned on, or in proximity to, basketball court, the user 201 may be a basketball enthusiast that enjoys shooting hoops, even without a basketball or basketball court.

Accordingly, the user 201 may use the footwear apparatus 101 to track the motion of one or both feet of the user 201, via the motion sensor 103. The AR glasses 102 may then receive the sensed motion data, and generate an AR basketball experience/game for the user 201. In other words, the glass portion of the AR glasses 102 displays various virtual objects (e.g., virtual basketball 602, virtual basketball net 603, etc.) within the context of the real-world environment 601 based on the sensed motion data determined by the motion sensor 103. In particular, the AR glasses 102 determine whether or not the user 201 is performing a jumping motion, and how that jumping motion is with respect to the virtual basketball net 603. The AR glasses 102 may then calculate and render a trajectory of the virtual basketball 602 with respect to the virtual basketball net 603. Further, FIG. 6B illustrates the display unit 108 of the AR glasses 102 rendering the virtual basketball net 603 as the user 201 is about to throw the virtual basketball 602 toward it.

FIG. 6C illustrates the user 201, in the real-world, jumping to throw the virtual basketball 602 toward the virtual basketball net 603. By tracking the motion of the motion sensor 103 (e.g., displacement, velocity, etc.), the processor 114 of the footwear apparatus 101 may determine a jumping motion of one or both feet of the user 201 with respect to the ground 604. In other words, the AR glasses 102 may infer the trajectory of the virtual basketball 602 based on the displacement and/or velocity of the jumping motion performed by the user 201. FIG. 6D illustrates the calculated trajectory of the virtual basketball 602 with respect to the virtual basketball net 603.

The foregoing user experiences (e.g., AR soccer, AR track and field, and AR basketball) are just examples of the possible AR applications of the footwear apparatus 101 in conjunction with the mobile computing device 102, illustrated in FIG. 1. The footwear apparatus 101 may be implemented in conjunction with the mobile computing device 102 to render a variety of other sports-related user experiences, and other user experiences that are not sports-related. Moreover, the foregoing user experiences are not limited to AR applications. For example, the user experience may be implemented via VR such that the user 201 is fully immersed in a virtual user experience, rather than a combination of virtual and real-world user experiences.

Additionally, the user experience may optionally be a game that has one or more rewards corresponding to benchmarks particular to that game. For example, the user 201 may win a particular medal for a certain number of soccer goals made, hurdles jumped, or basketball shots successfully made; such medal may correspond to a particular reward. For example, the reward may be specific to the particular AR experience and/or physical location of the user (e.g., a discount on basketball sneakers at a local sneaker store for certain number of basketball shots made while playing the AR basketball game).

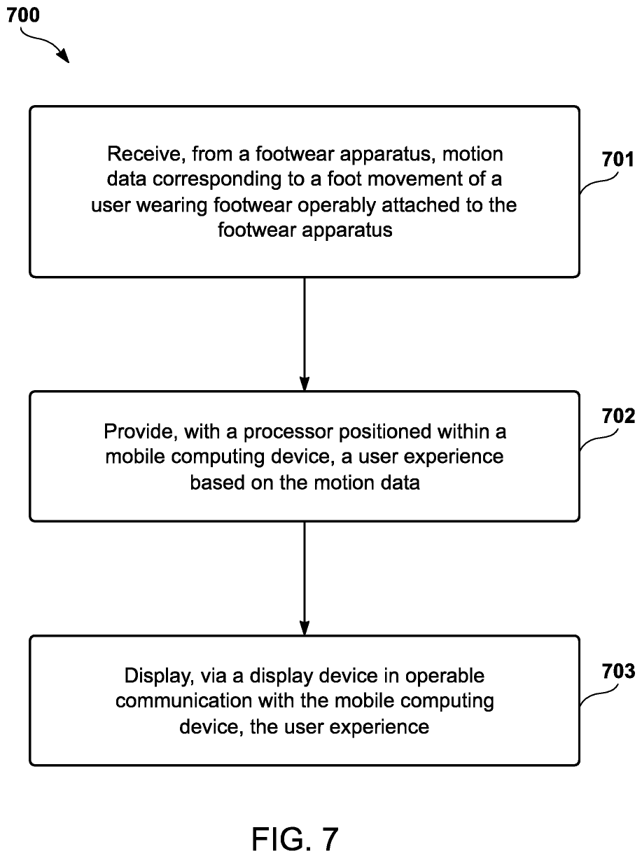

FIG. 7 illustrates a process that may be used by the mobile computing device 102, illustrated in FIG. 1, to render a user experience based on motion data captured by the footwear apparatus 101, also illustrated in FIG. 1. At a process block 701, the process 700 receives, from the footwear apparatus 102, motion data corresponding to a foot movement of the user 201 (FIG. 2) wearing footwear 202 operably attached to the footwear apparatus 101. The motion data is measured by one or more sensors 103 (FIG. 1) operably attached to the footwear 202. Further, at a process block 702, the process 700 provides, with the processor 106, illustrated in FIG. 1, positioned within the mobile computing device 102, a user experience based on the motion data. Finally, at a process block 703, the process 700 displays, via the display unit 108 in operable communication with the mobile computing device 102, the user experience.

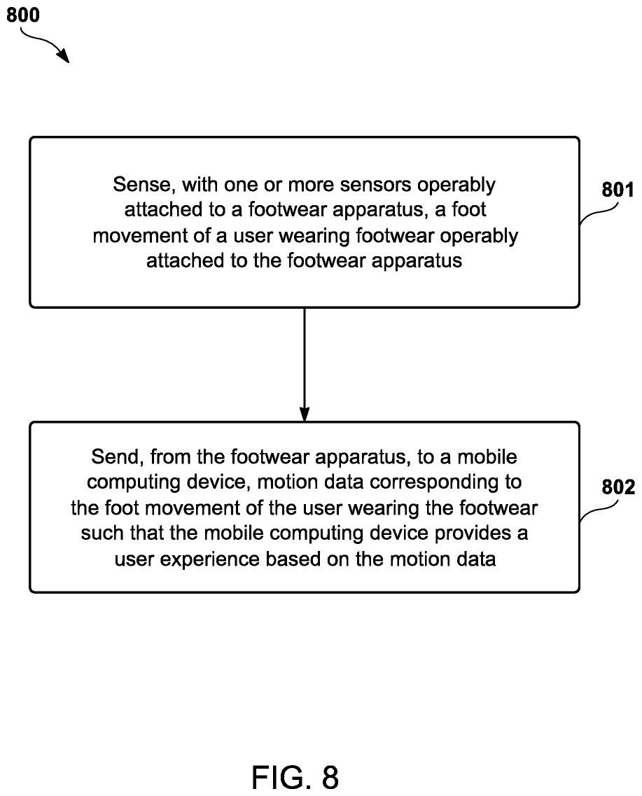

Further, FIG. 8 illustrates a process 800 that may be used by the footwear apparatus 101, illustrated in FIG. 1, to sense motion data of a foot of a the user 201, illustrated in FIG. 2. At a process block 801, the process 800 senses, with one or more sensors 103 operably attached to the footwear apparatus 101, a foot movement of the user 201 wearing footwear operably attached to the footwear apparatus 101. Further, at a process block 802, the process 800 sends, from the footwear apparatus 101 to a mobile computing device 102, motion data corresponding to the foot movement of the user 201 wearing the footwear such that the mobile computing device 102 provides a user experience based on the motion data.

With the positioning of the motion sensor 103 as provided for herein, the footwear apparatus 101 more accurately measures activity of the foot positioning of the user 201 than conventional configurations, thereby allowing for viable virtual-based user experiences that rely, at least in part, on foot positioning of the user 201. For example, an inaccurate determination of the foot positioning of the user 201, as could easily occur with a wrist-based fitness tracking device, could lead to the virtual soccer ball 402 (FIGS. 4A-4D) being rendered by the AR glasses 102 at an incorrect position (e.g., a few feet away from the actual location of the foot of the user 201), or not being rendered by the AR glasses 102 at all. The motion sensor 103 is placed on the footwear itself to accurately determine the foot positioning of the user 201, thereby allowing for virtual-based user experiences to be rendered in an accurate manner in which the user 201 may feasibly enjoy the virtual-based user experience.

Although a motion sensor 103 is provided for herein, other types of sensors may be used to provide other types of data that may be used for the AR experience. For example, a sensor may be positioned within the footwear apparatus 101 to measure foot weight, foot pressure, pressure points, etc.

The processes described herein may be implemented in a specialized, multi-purpose or single purpose processor. Such a processor will execute instructions, either at the assembly, compiled or machine-level, to perform the processes. A computer readable medium may be any medium capable of carrying those instructions and include a CD-ROM, DVD, magnetic or other optical disc, tape, silicon memory (e.g., removable, non-removable, volatile or non-volatile, packetized or non-packetized data through wireline or wireless transmissions locally or remotely through a network).

It is understood that the processes, systems, apparatuses, and compute program products described herein may also be applied in other types of processes, systems, apparatuses, and computer program products. Those skilled in the art will appreciate that the various adaptations and modifications of the embodiments of the processes, systems, apparatuses, and compute program products described herein may be configured without departing from the scope and spirit of the present processes and systems. Therefore, it is to be understood that, within the scope of the appended claims, the present processes, systems, apparatuses, and compute program products may be practiced other than as specifically described herein.

I claim:

1. A computer program product comprising a non-transitory computer useable storage device having a computer readable program, wherein the computer readable program when executed on a computer causes the computer to:
receive, from a footwear apparatus, motion data corresponding to a foot movement of a user wearing footwear operably attached to the footwear apparatus, the motion data being measured by one or more sensors operably attached to the footwear;
provide, with a processor positioned within a mobile computing device, a user experience based on the motion data; and
display, via a display device in operable communication with the mobile computing device, the user experience.

2. The computer program product of claim 1, wherein the mobile computing device is an augmented reality pair of glasses.

3. The computer program product of claim 1, wherein the mobile computing device is a smartphone.

4. The computer program product of claim 1, wherein the user experience is an augmented reality game in which the user participates via the foot movement of the user via user interaction with respect to a virtual object displayed by the mobile computing device.

5. The computer program product of claim 1, wherein the augmented reality game is soccer.

6. The computer program product of claim 1, wherein the computer is further caused to generate, and display via the augmented reality pair of glasses, a virtual map corresponding to a real-world geographic location, the virtual map displaying one or more geographic landmarks, the virtual map displaying one or more rewards-based indicia corresponding to the one or more geographic landmarks.

7. The computer program product of claim 6, wherein the user experience is a rewards-gathering game based on the virtual map.

8. The computer program product of claim 7, wherein the computer is further caused to receive global positioning data from the footwear apparatus, determine if the user is located at the one or more geographic landmarks via the global positioning data, and provide a reward based on the user being located at the one or more geographic landmarks.

9. The computer program product of claim 1, wherein the one or more sensors comprise one or more accelerometers.

10. The computer program product of claim 1, wherein the computer is further caused to receive the user experience from a remotely located server that generates the user experience.

11. The computer program product of claim 1, wherein the processor generates the user experience.

12. A computer program product comprising a non-transitory computer useable storage device having a computer readable program, wherein the computer readable program when executed on a computer causes the computer to:
sense, with one or more sensors operably attached to a footwear apparatus, a foot movement of a user wearing footwear operably attached to the footwear apparatus; and
send, from the footwear apparatus to a mobile computing device, motion data corresponding to the foot movement of the user wearing the footwear such that the mobile computing device provides a user experience based on the motion data.

13. The computer program product of claim 12, wherein the one or more sensors comprise one or more accelerometers.

14. The computer program product of claim 12, wherein the mobile computing device is an augmented reality pair of glasses.

15. The computer program product of claim 12, wherein the mobile computing device is a smartphone.

16. The computer program product of claim 12, wherein the user experience is an augmented reality game in which the user participates via the foot movement of the user via user interaction with respect to a virtual object displayed by the mobile computing device.

17. The computer program product of claim 12, wherein the mobile computing device generates, and displays, a virtual map corresponding to a real-world geographic location, the virtual map displaying one or more geographic landmarks, the virtual map displaying one or more rewards-based indicia corresponding to the one or more geographic landmarks.

18. The computer program product of claim 6, wherein the user experience is a rewards-gathering game based on the virtual map.

19. The computer program product of claim 7, wherein the computer is further caused to send global positioning data from the footwear apparatus to the mobile computing device such that the mobile computing device determines if the user is located at the one or more geographic landmarks via the global positioning data and provides a reward based on the user being located at the one or more geographic landmarks.

20. A footwear apparatus comprising:
footwear in which a foot of a user is positioned;
a sensor that senses a foot movement of a user wearing the footwear, the sensor being operably attached to the footwear; and
a transmitter that sends, from the footwear apparatus to a mobile computing device, motion data corresponding to the foot movement of the user wearing the footwear such that the mobile computing device provides a user experience based on the motion data, the transmitter being operably attached to the footwear.
